(19) United States
(12) Patent Application Publication
(10) Pub. No.: US 2012/0005687 A1
(43) Pub. Date: Jan. 5, 2012

(54) SYSTEM ACTIVATION METHOD IN MULTI-TASK SYSTEM

(75) Inventor: Yusuke Ito, Hyogo (JP)

(73) Assignee: PANASONIC CORPORATION, Osaka (JP)

(21) Appl. No.: 13/220,063

(22) Filed: Aug. 29, 2011

Related U.S. Application Data
(63) Continuation of application No. PCT/JP2010/000791, filed on Feb. 9, 2010.

(30) Foreign Application Priority Data
Mar. 11, 2009 (JP) 2009-057976

(51) Int. Cl. G06F 9/46

(52) U.S. Cl. 718/107

(57) ABSTRACT

When a multi-task system is powered on, the following steps are respectively executed: a first step in which hardware components are initialized; a second step in which sections are initialized; and a third step in which an operating system is initialized. In the third step, a task/object is statically generated when an initial access time of the task/object is at most a predefined threshold value but the task/object is dynamically generated after activation of the multi-task system is completed when the initial access time of the task/object is larger than the predefined threshold value.

### FIELD OF THE INVENTION

The present invention relates to a method for generating tasks and objects (for example, semaphore, event flag) in a multi-task system, more particularly to a technology for shortening an activation time to more speedily activate the system.

### BACKGROUND OF THE INVENTION

Keeping pace with the advancement of program control in recent years, a multi-task system configured to synchronously process at least two tasks, each of which is a work unit of a computer, was developed and is becoming widespread. The multi-task system thus configured can efficiently execute a plurality of tasks by switching from one task to another. Along with the advancing technology, an operating system which helps to improve the performance of developing embedded software (hereinafter, called OS) is often used. An example of the embedded OS prevailing among consumers now is uITRON4.0. The OS can describe an application in the form of function-based tasks, thereby improving the fungibility of resources.

In the description given below, a personal computer embedded with various user-oriented software programs before shipped and sold in the market is called a product set. Since an ongoing trend of such a product set is fast-paced improvement of multi-functionality and high-functionality, a larger number of software programs that are more complicated are now embedded in the product set, and some software programs may demand the union of assets (tasks) in other fields. Conventionally, the software programs embedded in the conventional product sets had approximately 10-20 tasks to be processed by a computer. The software programs available these days which demand the union of assets (tasks) in other fields may have, for example, more than 100 tasks, complicating a task designing process.

A great need for the product sets is reduction of a system activation time. The effort for reducing the activation time is, however, challenged by the unsolved technical problem that it takes more time to generate and initialize tasks when the system is activated as tasks to be generated increase.

FIG. 11 an illustration of initialization steps on a time axis when a conventional multi-task system equipped with a conventional OS is activated. From time t0 to time t1, hardware components are initialized, for example, buses and various registers are reset. From time t1 to time t2, sections are initialized. Then, from time t2 to time t3, OS is initialized. After the initialization steps are all completed, a user is able to use any arbitrary functions.

During the OS initialization, variables used by OS are initialized, and tasks/objects are generated. The task/object includes at least one of a task and an object. To generate the task/object needs an initialization time. The initialization time changes depending on the number of tasks or objects to be generated, which is a bottleneck in reducing the activation time in any large-scale systems recently available (product sets with more tasks).

There are two different manners of generating the tasks/objects used by OS; static generation in which the tasks/objects are generated when the system is activated, and dynamic generation in which a particular system call is invoked in an application to generate the tasks/objects after the system is activated. Though the system activation time is shortened when the dynamic generation is performed apart from the static generation, it is necessary in that case to select and differently design the tasks, resulting in complicated processing steps.

The Patent Document 1 discloses a system activation apparatus as another prior art developed to shorten the system activation time. In the multi-task system, the apparatus reads information of each task from an information table and a state table into a task information storage when the system is activated, checks states of the respective tasks demanded by the system relevant to the last system halt, and activates only the tasks which were operational at the last system halt to shorten the system activation time. FIG. 12 is an illustration of initialization steps on a time axis when the conventional multi-task system disclosed in the Patent Document 1 is activated. From time t0 to time t1, hardware components are initialized. From time t1 to time t2, sections are initialized. Then, from time t2 to time 3, only the tasks which were operational before the last system halt are activated. Thus, the conventional apparatus can narrow down the tasks to be activated to the tasks which were operational before the last system halt, thereby reducing the system activation time.

### PRIOR ART DOCUMENT

### Patent Document

Patent Document 1: Unexamined Japanese Patent Application Laid-Open No. 08-286936

### SUMMARY OF THE INVENTION

### Problem to be Solved by the Invention

As described earlier, the conventional apparatus can narrow down the tasks to be activated to the tasks which were operational before the last system halt to reduce the system activation time, while failing to shorten the system activation time in the case where all of the tasks were operational before the last system halt. Thus, a large number of operational tasks weaken the effect of reducing the activation time.

The configuration of tasks in the product sets sold in recent years is characterized in that various fungible assets constitute a system. For example, it might be necessary to activate some tasks before and/or after a target task when the target task is activated, in which case the system fails to properly execute necessary processing steps when only the target task is activated again, possibly resulting in malfunctioning.

Further, the prior art still needs a large amount of time similarly to the normal activation illustrated in FIG. 1 in order to activate the system for the first time or activate the system for any processes different to processes which were operational before the last system halt, failing to reduce the system activation time.

The present invention was accomplished to solve the conventional technical problems, and a main object thereof is to effectively reduce a system activation time of a multi-task system.

### Means for Solving the Problem

A system activation method in a multi-task system according to the present invention comprises:

a first step in which hardware components are initialized;

a second step in which sections are initialized; and

a third step in which an operating system is initialized,

the three steps respectively being executed when the multi-task system is powered on, wherein

a task/object is statically generated when an initial access time of the task/object is at most a predefined threshold value but the task/object is dynamically generated after activation of the multi-task system is completed when the initial access time of the task/object is larger than the predefined threshold value in the third step.

The initial access time is a length of time consumed for accessing each task/object for the first time. When the task/object is statically generated in the multi-task system, the static generation conventionally should end within an activation time. When the task/object is dynamically generated in the multi-task system, on the other hand, the dynamic generation conventionally should end by the time when the system starts to be used after the system activation is completed. When the task/object is dynamically generated, it is preferable to dynamically generate the task/object during an idle state after the system activation is completed.

Thus, the present invention is technically characterized in that a restriction is imposed on the number of tasks/objects to be statically generated within a given period of time of OS initialization. The task/object is statically generated as far as its initial access time is relatively short, whereas any other task/object whose initial access time is longer than the predefined value is not generated within the given period of time of OS initialization but is generated after the system activation is completed (dynamically generated).

When the initial access time is thus set to be relatively short for any tasks/objects which are demanded by the OS initialization within the given period of time after the system is activated, the tasks/objects to be generated can be minimized. Any tasks/objects unlikely to be accessed over the given period of time are not generated during the OS initialization. The present invention thus characterized restricts the number of tasks/objects to be generated during the OS initialization to reduce a length of time from the start to completion of the system activation (system activation time), thereby accelerating the system activation. For example, it might be necessary to activate some tasks before and/or after a target task when the target task is activated, in which case the present invention can choose such tasks as tasks to be activated. Thus configured, the system can normally operate to reliably execute any demanded processes.

To activate the system for the first time or execute any processes different to processes which were operational before the last system halt, the tasks/objects which are necessary within the given period of time after the system is activated are selectively generated so that the system activation time can be reduced.

The task/object conventionally dynamically generated can be statically generated as far as it is frequently used, which improves responsiveness when the task/object frequently used is requested.

The threshold value is preferably calculated based on an activation time of the multi-task system in the task/object in the third step. The length of time from the start to completion of the system activation is set as the system activation time. The threshold value is set to such a length of time within the activation time that can guarantee accessibility to the task/object of an arbitrary function so that the arbitrary function is acceptable as well as the initialization of hardware components and the initialization of sections.

The initial access time is preferably updated depending on a user's usage situation. A length of time for the task/object to be actually accessed upon a user's activation request after the activation is completed (actual access time) is variable depending on the user's usage situation. When the feedback of the actual access time is reflected on the initial access time depending on the user's usage situation, the system activation time can be more effectively shortened in a manner suitable for the user's usage situation and/or preference. For example, a function more frequently used can be preferentially initialized over the other functions. The task/object conventionally dynamically generated can be statically generated as far as it is frequently used so that responsiveness when the task/object is requested can be improved.

To update the initial access time depending on the user's usage situation, the actual access time is preferably accumulated and averaged.

The initial access time in the system activation method is preferably set by the user. When the initial access time is thus differently set, the initial access time of the task/object of any function wanted by the user can be set by the user at his discretion so that the wanted task/object is preferentially generated.

In the system activation method, the multi-task system preferably has a list of objects necessary to use particular functions and information of the initial access time of each of the functions to be used so that the initial access time of the object is set based on the list of objects and the initial access time information. The tasks/objects used per function are organized as a group so that the initial access time per function is set and updated, which facilitates an increasing range of functions and a broader versatility.

### Effect of the Invention

The present invention is technically characterized in that when the multi-task system is activated, the system activation method selects one of the static generation and the dynamic generation depending on the comparison result of the initial access time of the task/object to the given threshold value. More specifically, the task/object is statically generated as far as its initial access time is relatively short, whereas any other task/object whose initial access time is relatively long is not generated within the given period of time of OS initialization but is generated after the activation is completed. This technical advantage can effectively reduce the system activation time under the circumstances where the tasks/objects to be generated tend to increase, thereby accelerating the system activation.

For example, it might be necessary to activate some tasks before and/or after a target task when the target task is activated, in which case the present invention can choose such tasks as tasks to be activated. Thus configured, the system can normally operate to reliably execute any demanded processes, while ensuring speedy activation with less time.

To activate the system for the first time or execute any processes different to processes which were operational before the last system halt, the tasks/objects which are needed within the given period of time after the system is activated are selectively generated so that the system activation time can be reduced.

The task/object conventionally dynamically generated can be statically generated as far as it is frequently used, which improves responsiveness when the task/object frequently used is requested.

### BRIEF DESCRIPTION OF THE DRAWINGS

FIG. 1 is a block diagram illustrating a system configuration of a multi-task system to which a system activation method according to an exemplary embodiment of the present invention is applied.

FIG. 2 is an illustration of a system activation time and an initial access time in the system activation method according to the exemplary embodiment used in the multi-task system.

FIG. 3 is a flow chart illustrating processing steps in the system activation method according to the exemplary embodiment used in the multi-task system.

FIG. 4 is a flow chart illustrating in detail processing steps for initializing OS in Step S4 of FIG. 3.

FIG. 5A is an illustration of a table of generated information to which the initial access time is added in the system activation method according to the exemplary embodiment used in the multi-task system.

FIG. 5B is an illustration of a table of generated information to which the initial access time is added in the system activation method according to the exemplary embodiment used in the multi-task system.

FIG. 6 is a chart illustrating the initial access time of FIGS. 5A and 5B and whether tasks/objects are generated.

FIG. 7 is a flow chart illustrating processing steps including dynamic generation using a scheduler in Step S7 of FIG. 3.

FIG. 8 is a flow chart illustrating processing steps for updating the initial access time in the system activation method according to the exemplary embodiment used in the multi-task system.

FIG. 9 illustrates an example in which initial access information is retained per unit in the system activation method according to the exemplary embodiment used in the multi-task system.

FIG. 10 is an illustration of initialization steps on a time axis in the system activation method according to the exemplary embodiment used in the multi-task system.

FIG. 11 is an illustration of initialization steps on a time axis in a conventional multi-task system equipped with a conventional OS.

FIG. 12 is an illustration of initialization steps on a time axis in another conventional multi-task system.

### EXEMPLARY EMBODIMENTS FOR CARRYING OUT THE INVENTION

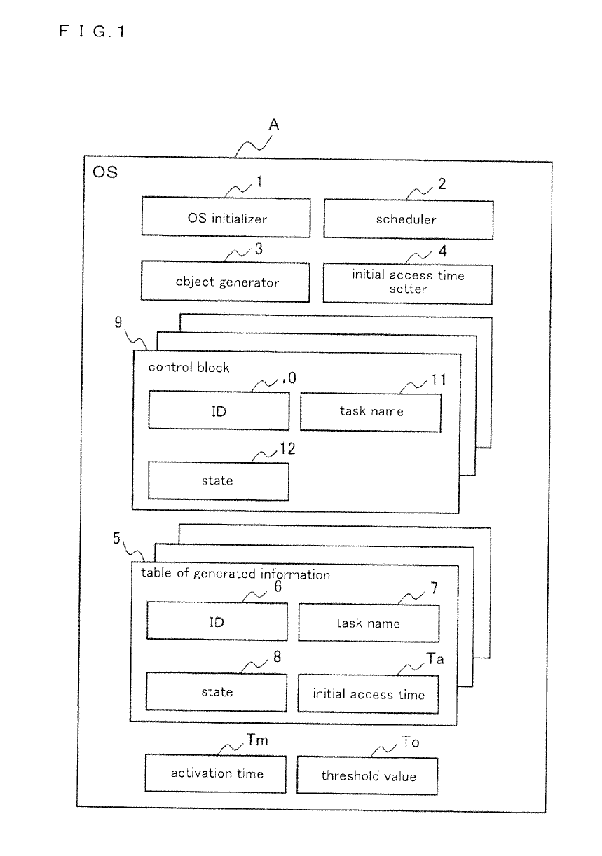

Hereinafter, an exemplary embodiment of a system activation method used in a multi-task system according to the present invention is described in detail referring to the drawings. FIG. 1 is a block diagram illustrating a system configuration of a multi-task system A to which the system activation method according to the exemplary embodiment is applied. The multi-task system A comprises an OS initializer 1, a scheduler 2, an object generator 3, an initial access time setter 4, a table of generated information 5, and a control block 9.

The OS initializer 1 is in charge of initializing OS. The scheduler 2 selects one of tasks to be executed by the multi-task system A based on a system call issued from each task. The object generator 3 generates a task/object. The task/object includes at least one of a task and an object. The initial access time setter 4 sets a length of time necessary for the multi-task system A to access the task/object for the first time (hereinafter, called initial access time Ta). The user uses the initial access time setter 4 to set the initial access time Ta. The table of generated information 5 has data for generating the control block 9 in charge of access control. The control block 9 stores therein an activation time of the system A guaranteed by the system A (hereinafter, called activation time Tm), a threshold value To which is a reference value for comparison to the initial access time Tm, and a state of each object. The state of each object is, for example, semaphore and event flag.

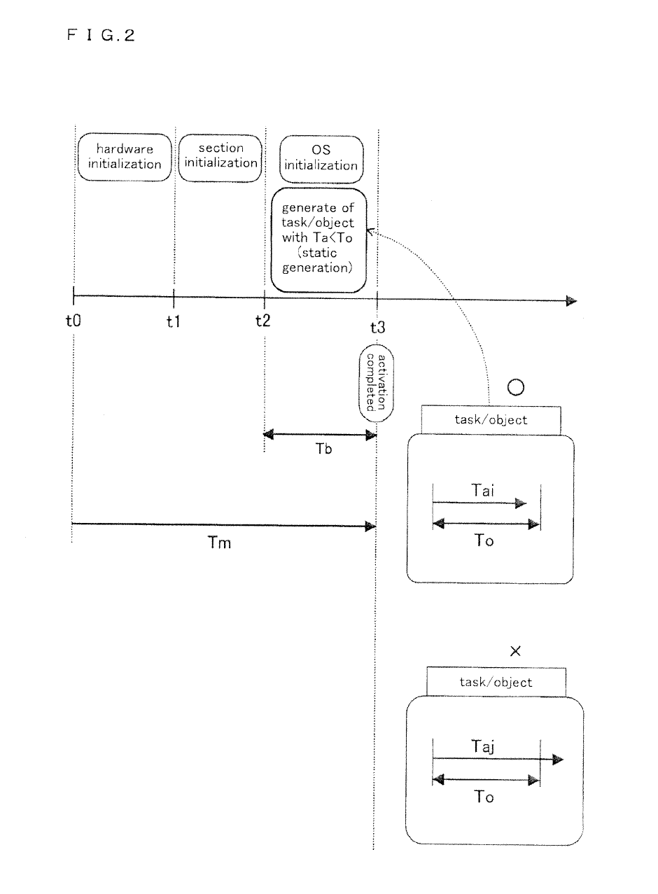

FIG. 2 is an illustration of the activation time Tm and the initial access time Ta in the system A. The activation time Tm is a length of time guaranteed in the system A as a product, more specifically a length of time from the start to completion of the system activation. The length of time includes a length of time necessary for hardware components in the system A to be initialized (hereinafter, hardware initialization time), a length of time necessary for sections in the system A to be initialized (hereinafter, called section initialization time), a length of time necessary for OS embedded in the system A to be initialized (hereinafter, called OS initialization time), and a length of time anticipated for the tasks/objects to be generated in the system A (hereinafter, called object generation time).

More specifically describing the initial access time Ta, it is a length of time consumed for the task/object to be accessed for the first time after the activation of the system A is completed. The initial access time Ta is set in each task/object by the initial access time setter 4.

The threshold value To is calculated based on the system activation time Tm. The hardware initialization time and the section initialization time are subtracted from the activation time Tm, and a subtraction result Tb thereby obtained is calculated as a maximum length of time that can be used for the OS to generate the tasks/objects.

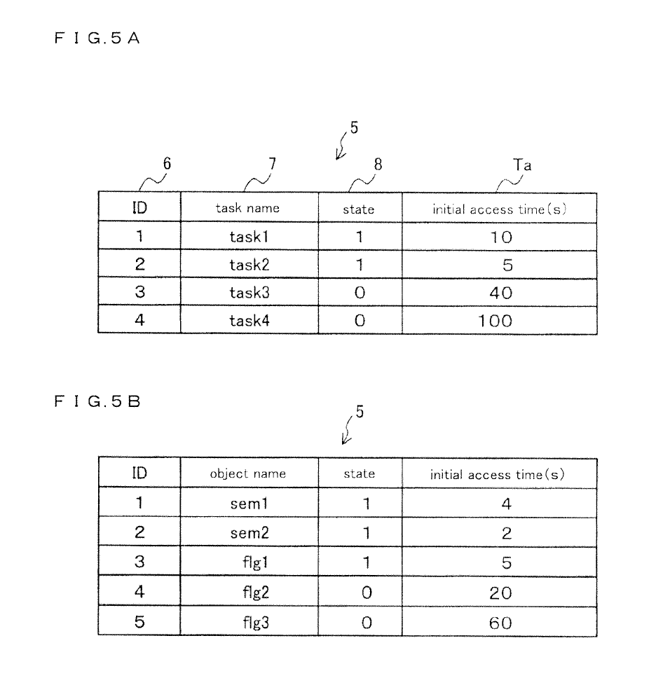

Referring to FIG. 1 again, each task/object has the table of generated information 5, and the table of generated information 5 contains therein ID 6, task name 7, state 8, and initial access time Ta. FIGS. 5A and 5B illustrate specific examples of the table of generated information 5.

The control block 9 is different in each task/object. Describing reference numerals of the control block 9, 10 is the ID, 11 is the task name, and 12 is the state. When the task/object is statically or dynamically generated, information necessary for generating the control block 9 is read from the table of generated information 5 as an indispensable prerequisite so that the control block 9 is generated.

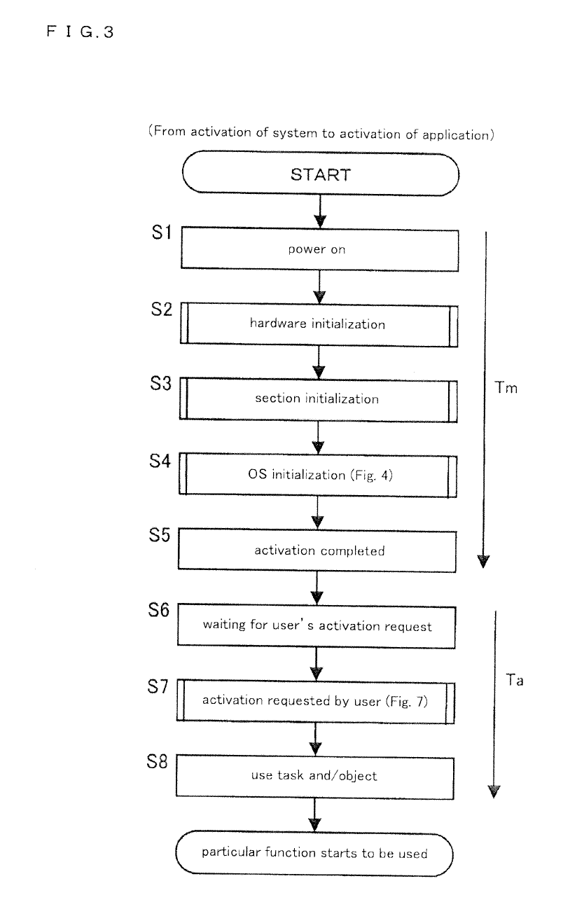

Next, processing steps of the system activation method in the multi-task system including the OS thus configured are described referring to a flow chart illustrated in FIG. 3.

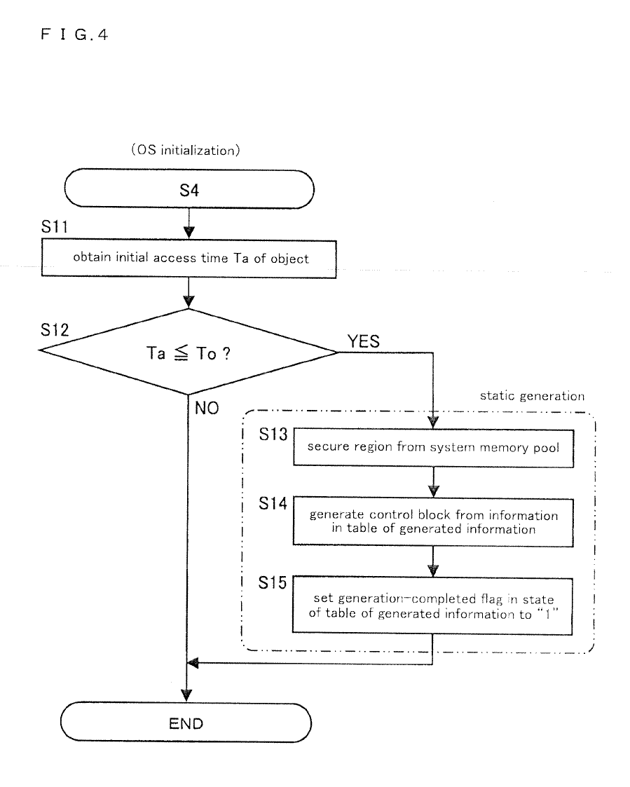

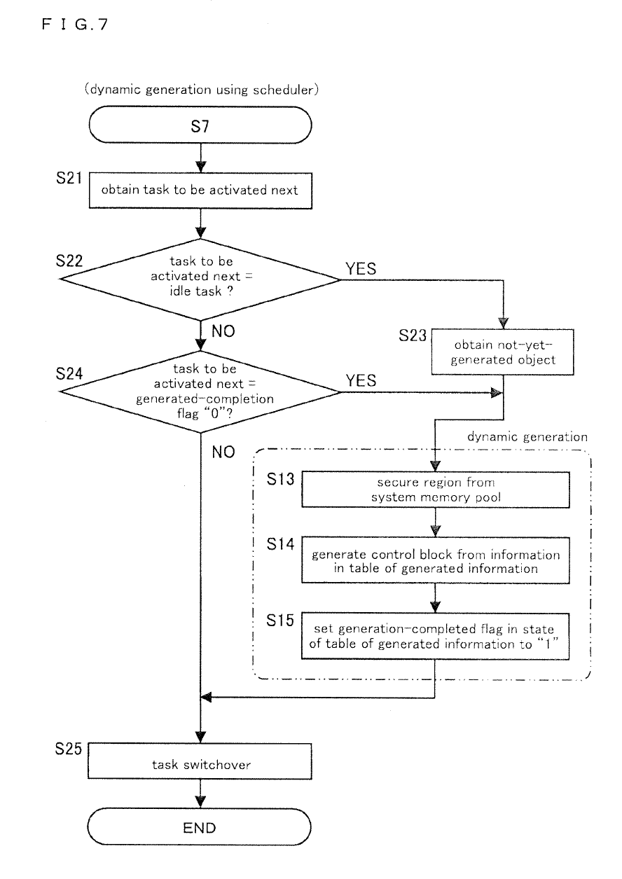

In Step S1, the system A is powered on as requested by a user. In Step S2, the hardware components are initialized. The hardware components to be initialized are, for example, buses and registers. In Step S3, the sections are initialized. In Step S4, the OS is initialized. When the OS is initialized, the tasks/objects generation and OS region setting, for example, are initialized. Step S4 will be described in detail later referring to FIG. 4. In Step S5, the activation steps are completed, and the system is now ready to accept any arbitrary function requested by the user. In Steps S6 and S7, the system waits for a request to activate any desirable function from the user. Step S7 will be described in detail later referring to FIG. 7. After confirming that the user's activation request is inputted in Step S7, the task/object starts to be used in the OS, and the requested function starts to operate.

A length of time from the power on (Step S1) to the system activation completion (Step S5) is the system activation time Tm. The activation time Tm should be guaranteed as an indispensable prerequisite for the system. A length of time from the completed activation in Step S5 followed by the input of the user's activation request until the task/object is accessed in Step S8 is the initial access time Ta. In Step S4, only the tasks/objects which are necessary for the OS initialization are generated but any tasks/objects which are unlikely to be accessed over a given period of time are generated after the activation is completed, so that the system activation time Tm is reduced.

Next, processing steps for reducing the activation time in Step S4 are described in detail referring to FIGS. 4-6. FIG. 4 is a flow chart illustrating in detail processing steps for initializing the OS in Step S4 of FIG. 3. FIGS. 5A and 5B illustrate examples of the table of generated information 5 to which the initial access time is added.

In Step S11, the OS initializer 1 obtains the initial access time Ta of an arbitrary task/object included in the table of generated information 5. Each task/object has the table of generated information 5 in which the initial access time is set (illustrated in FIGS. 5A and 5B). The object includes, for example, semaphore and event flag.

In Step S12, the OS initializer 1 compares the obtained initial access time Ta to the threshold value To. When the OS initializer 1 determines that the initial access time Ta is at most the threshold value To (Ta≦To), the OS initializer 1 proceeds to Step S13 which starts a series of task/object static generation steps. When the OS initializer 1 determines that the initial access time Ta is larger than the threshold value To (Ta>To), the OS initializer 1 skips Steps S13-S15 and proceeds to Step S5 illustrated in FIG. 3.

In Step S13, the object generator 3 secures an enough memory capacity to generate the control block 9. In Step S14, the object generator 3 generates the control block 9 based on the data of the table of generated information 5. In Step S15, the object generator 3 sets a generation-completed flag in the state 8 of the table of generated information 5 to “1”.

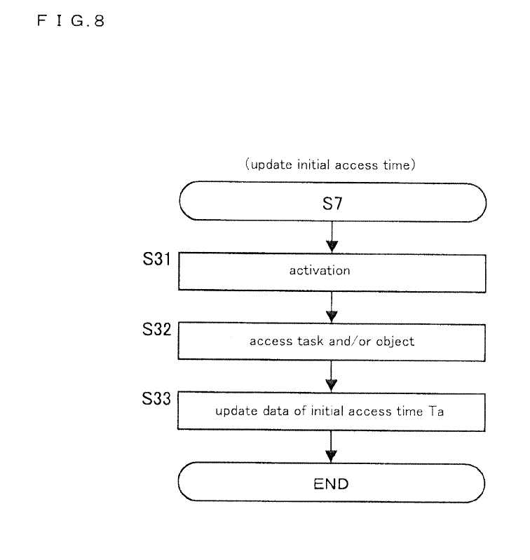

Any object determined as having the initial access time Ta larger than the threshold value To (Ta>To) is not initialized then but is generated in dynamic generation steps illustrated in FIG. 8 later. Therefore, the object generator 3 sets the generation-completed flag in the state 8 of the table of generated information 5 to “0”.

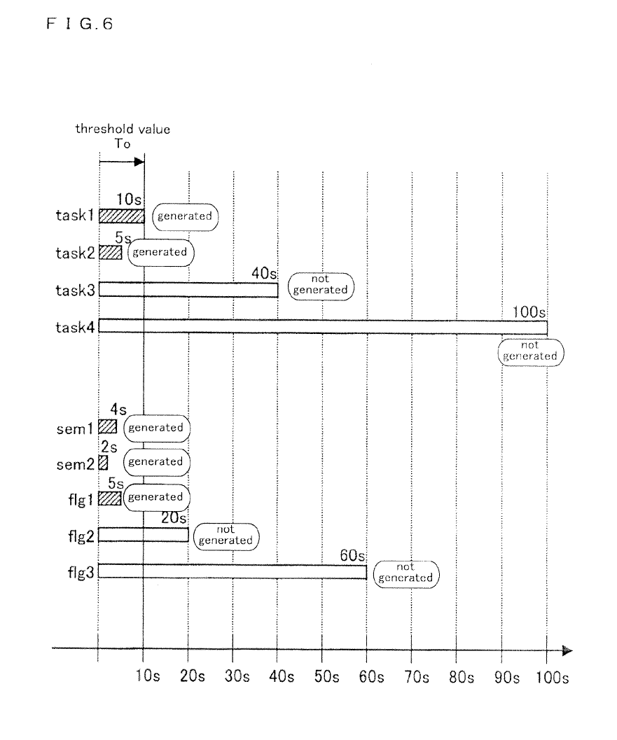

When the threshold value To illustrated in the example of FIG. 5 is, for example, 10 seconds, the task/objects to be statically generated are task1, task2, sem1, sem2, and flg1, while the rest of the tasks/objects are generated after the system is activated. Thus, the tasks/objects which are needed to initialize the OS within the given period of time after the system is activated are selectively generated, whereas any tasks/objects which are unlikely to be accessed over the given period of time are generated later. As a result, the activation time Tm can be reduced. FIG. 6 is a chart illustrating the initial access time of FIGS. 5A and 5B and whether tasks/objects are generated.

Next, processing steps in Step S7 are described in detail below. The processing steps, which are targeted for any tasks/objects excluded from the tasks/objects to be statically generated, are dynamic generation steps. FIG. 7 is a flow chart illustrating the processing steps including dynamic generation using the scheduler 2 in Step S7 of FIG. 3.

When the user's activation request is inputted in Step S7 after the system activation is completed, the scheduler 2 is invoked at the time of task switchover. In Step S21, the invoked scheduler 2 obtains the task to be activated next. In Step S22, the scheduler 2 determines whether the obtained task to be activated next is an idle task. The scheduler 2 proceeds to Step S23 when the task to be activated next is determined as an idle task, while proceeding to Step S25 when the task to be activated next is not an idle task.

In Step S23, the object generator 3 obtains information of the object with the state flag indicating “0” which was not statically generated when the system was activated from the table of generated information 5. Further, the object generator 3 invokes Steps S13-S15 to (dynamically) generate a target task/object by the time when the target task/object becomes necessary for the activation steps. In Step S25, the scheduler 2 performs the task switchover.

To obtain the not-yet-generated object in Step S23, the task/object with the shortest initial access time Ta in all of the not-yet-generated tasks/objects may be preferentially generated, or the objects are organized as a group per function so that any tasks/objects which are more likely to be invoked are preferentially generated at a plurality of positions.

In Step S24, the scheduler 2 determines whether the generation-completed flag indicating the state of the task to be activated next is “0”. After confirming that the generation-completed flag indicates “0”, Steps S13-S15 for generating the task/objects are similarly invoked so that the target task/object is (dynamically) generated. After confirming that the generation-completed flag does not indicate “0”, the scheduler 2 proceeds to Step S25 for the task switchover.

A method for updating the initial access time Ta is described referring to a flow chart illustrated in FIG. 8. In Step S31, the system is activated. In Step S32, the task/object is then accessed. In Step S33, the initial access time Ta is updated to an actual length of time from the system activation in Step S31 to the access completion in Step S32. To update the initial access time Ta, the initial access time Ta of the task/object is added to the previous value of the initial access time Ta, and a resulting value is averaged and set. As the initial access time Ta is thus updated a plurality of times, any function more frequently used can be preferentially initialized depending on the user's usage situation and/or preference.

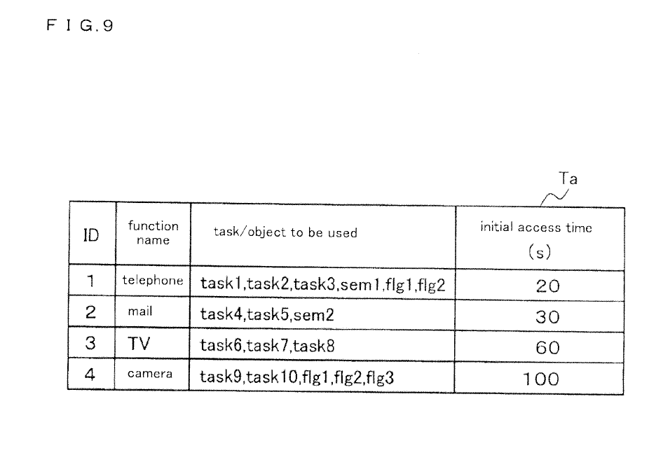

The initial access time Ta may be set by retaining the initial access time Ta as an initial value in a designing process, or the initial access time setter 4 may be preset so that any function wanted by the user is preferentially generated. As illustrated in FIG. 9, the initial access time Ta may be set and/or updated per function or a group of tasks/objects used per function. Further, it may be arranged to statically generate the tasks which are conventionally dynamically generated. These arrangements can improve responsiveness of any functions frequently used.

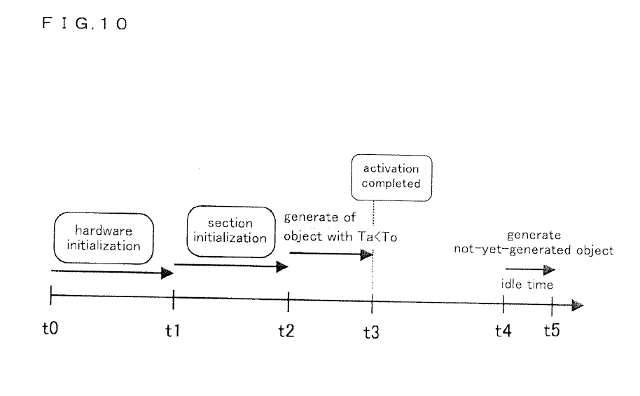

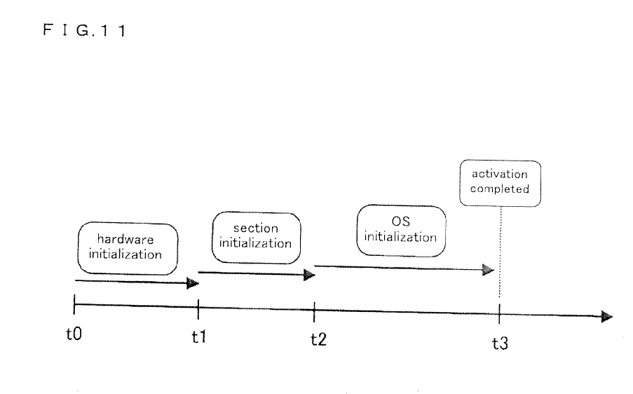

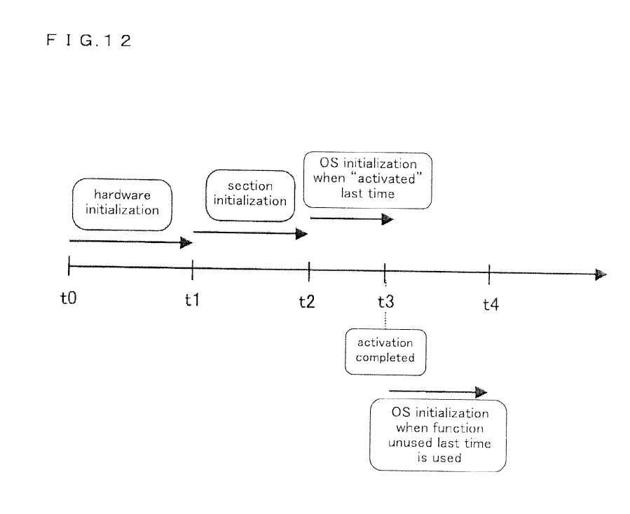

FIG. 10 is an illustration of initialization steps on a time axis in the system activation method according to the exemplary embodiment. From time t0 to time t1, the hardware components are initialized. From time t1 to time t2, the sections are initialized. In the OS initialization step from time t2 to time 3, the initial access time is compared to the threshold value, and only the tasks/objects which are necessary for initializing the OS within the given period of time after the system is activated are statically generated based on a result of the comparison, meaning that the tasks/objects which are unlikely to be accessed over the given period of time are generated later. From time t4 to time t5 after the activation is completed at time t3, the objects which were not generated when the system was initialized are dynamically generated. The present invention is not necessarily limited to the exemplary embodiment described so far, and can be variously modified within the technical scope of the present invention.

### INDUSTRIAL APPLICABILITY

The system activation method in the multi-task system according to the present invention is an advantageous technology for shortening an activation time of a system loaded with a multi-task OS to more speedily activate the system.

### DESCRIPTION OF REFERENCE SYMBOLS

A multi-task system
1 OS initializer
2 scheduler
3 object generator
4 initial access time setter
5 table of generated information
Ta initial access time
Tm activation time
To threshold value

1. A system activation method in a multi-task system, comprising:
a first step in which hardware components are initialized;
a second step in which sections are initialized; and
a third step in which an operating system is initialized,
the three steps respectively being executed when the multi-task system is powered on, wherein
a task/object is statically generated when an initial access time of the task/object is at most a predefined threshold value but the task/object is dynamically generated after activation of the multi-task system is completed when the initial access time of the task/object is larger than the predefined threshold value in the third step.

2. The system activation method in the multi-task system as claimed in claim 1, wherein
the task/object is generated by the time when the activation of the multi-task system is completed so that the task/object is statically generated in the third step.

3. The system activation method in the multi-task system as claimed in claim 1, wherein
the task/object is generated during a period of time from the completion of the activation of the multi-task system until the system started to be used so that the task/object is dynamically generated in the third step.

4. The system activation method in the multi-task system as claimed in claim 3, wherein
the task/object is generated during an idle state after the activation of the multi-task system is completed so that the task/object is dynamically generated in the third step.

5. The system activation method in the multi-task system as claimed in claim 1, wherein
the threshold value is calculated based on an activation time of the multi-task system in the task/object in the third step.

6. The system activation method in the multi-task system as claimed in claim 1, wherein
the initial access time is updated depending on a usage situation of a user of the multi-task system in the third step.

7. The system activation method in the multi-task system as claimed in claim 1, wherein
the initial access time is arbitrarily set by the user of the multi-task system in the third step.

8. The system activation method in the multi-task system as claimed in claim 1, wherein
the multi-task system has a list of objects necessary to use particular functions and information of the initial access time of each of the functions to be used, and
the initial access time of the object is set based on the list of objects and the initial access time information in the third step.
